(19) United States
(12) Patent Application Publication
(10) Pub. No.: US 2013/0012375 A1
(43) Pub. Date: Jan. 10, 2013

(54) ULTRA HIGH MOLECULAR WEIGHT POLYETHYLENE CATALYSTS AND PROCESSES FOR THE PREPARATION THEREOF

(76) Inventors: Liuzhong Li, Zibo City (CN); Jianyong Zhou, Zibo City (CN); Xiaoqing Li, Zibo City (CN); Xiaolong Bi, Zibo City (CN); Wenyi Li, Zibo City (CN); Yongling Yu, Zibo City (CN); Jie Yan, Zibo City (CN); Lifang Qi, Zibo City (CN); Gongtao Li, Zibo City (CN); Dapeng Fan, Zibo City (CN); Xiao Xu, Zibo City (CN); Xiaojing Pei, Zibo City (CN)

(21) Appl. No.: 13/540,982

(22) Filed: Jul. 3, 2012

(30) Foreign Application Priority Data
Jul. 4, 2011 (CN) 201110185255.6
Jul. 4, 2011 (CN) 201110185502.2

(51) Int. Cl. C08F 4/646

(52) U.S. Cl. 502/5; 502/118

(57) ABSTRACT

Disclosed herein is a process for preparation of an ultra high molecular weight polyethylene catalyst, comprising: (1) under inert atmosphere, dispersing a magnesium halide in an inert solvent; (2) adding an alcohol to react with the magnesium halide, to form a solution or dispersion of a magnesium halide-alcohol adduct; (3) adding an alkyl aluminum halide to react with the magnesium halide-alcohol adduct, to form an intermediate product; (4) optionally, subjecting the intermediate product to an ultrasonic wave treatment; (5) adding a titanium compound to perform Ti-supporting reaction; (6) optionally, subjecting the reaction mixture from step (5) to an ultrasonic wave treatment; and (7) recovering solid particles, to obtain the ultra high molecular weight polyethylene catalyst, wherein at least one of steps (4) and (6) is present.

The present application claims the priority of Application Nos. CN201110185255.6 filed on Jul. 4, 2011 and CN201110185502.2 filed on Jul. 4, 2011, which are incorporated herein by reference in its entirety and for all purposes.

The present invention relates to an ultra high molecular weight polyethylene catalyst, a process for the preparation thereof, and polymer products obtained thereby.

Ultra high molecular weight polyethylenes (UHMWPE's) have generally a molecular weight of more than 1,500,000 and even several millions, have excellent properties such as excellent impact resistance, self-lubricity, chemical resistance, stress cracking resistance, electroinsulating property, abrasive resistance, and find use in many applications such as spinning, paper making, transportation, packaging, machinery, chemical industry, mining, petroleum industry, agriculture, construction, medical treatment, sports, and refrigeration, especially in the production of parts requiring high physical properties, such as gear and artificial joints, and in the production of high strength fibers.

Catalysts used in the production of UHMWPE's include mainly Ziegler-Natta catalysts, chromium-based catalysts, metallocene catalysts. Among these, Ziegler-Natta UHMWPE catalysts are the most mature in technology and the most widely used.

There are many processes for preparation of a Ziegler-Natta catalyst in the art. For example, JP49-51378 discloses a process for the preparation of a catalyst useful in the polymerization and copolymerization of ethylene, comprising reacting magnesium dichloride with ethanol in a mineral oil medium to form a slurry of magnesium dichloride-alcohol adduct, reacting the slurry of magnesium dichloride-alcohol adduct with diethyl aluminum chloride to remove most of ethanol in the adduct, and finally adding TiCl₄ to perform Ti-supporting reaction, to afford a Ti/MgCl₂ supported catalyst.

CN101074275A discloses a process for the preparation of an ultra high molecular weight polyethylene catalyst, comprising reacting a magnesium halide with an alcohol and a titanate compound to form a magnesium compound solution, reacting the magnesium compound solution with an alkyl aluminum chloride to form an intermediate product, and reacting the intermediate product with a titanium compound and an electron donor, to afford a desired catalyst.

CN1861650A discloses a process for the preparation of a Ziegler-Natta catalyst useful in the slurry polymerization of ethylene, which process utilizes ultrasonic wave treatment technology during the catalyst preparation to enhance a titanium content of the catalyst and to effectively improve particle size distribution of polymers. Experimental results show that the use of the ultrasonic wave treatment technology results in polymers having high bulk densities.

CN1506384A discloses the use of ultrasonic wave treatment in the preparation of a catalyst for propylene polymerization to enhance catalyst activity and polymer bulk density.

The works in the prior art focus mainly on the improvement of catalyst activity and the enhancement of polymer molecular weight and polymer bulk density, whereas the catalyst activity and the polymer molecular weight are enhanced to a limited extent. Furthermore, ultra high molecular weight polyethylenes having a lower bulk density are not given attention.

Disclosed herein is an ultra high molecular weight polyethylene catalyst, which has a high catalytic activity, and exhibits smooth reaction kinetics behavior so that the control of the polymerization process is easy.

Also disclosed herein is a process for preparation of the ultra high molecular weight polyethylene catalyst, wherein ultrasonic wave treatment technology is employed.

Even further disclosed herein is an ultra high molecular weight polyethylene resin, which is produced by using the catalyst disclosed herein, has a high molecular weight, a low bulk density, and a porous, loose particle structure.

### BRIEF DESCRIPTION OF DRAWINGS

FIG. 1 shows polymerization reaction kinetics plots for the catalysts obtained in Examples 1, 18 and 26.

FIG. 2 shows scanning electron micrographs of polymer particles obtained in Examples 1, 18 and 26 and Comparative Example 1.

As used herein, the term “ultra high molecular weight polyethylene” (UHMWPE) is intended to mean a polyethylene having a viscosity-average molecular weight of more than 1,500,000, which is generally of linear structure.

As used herein, the term “catalyst” is intended to mean main catalyst component or procatalyst, which, together with a conventional cocatalyst, for example an alkyl aluminum, constitutes the catalyst system for ethylene polymerization.

As used herein, the term “ultra high molecular weight polyethylene catalyst” is intended to mean a catalyst useful in the production of ultra high molecular weight polyethylenes.

Disclosed herein is a process for preparation of an ultra high molecular weight polyethylene catalyst, comprising:

(1) under inert atmosphere, dispersing a magnesium halide in an inert solvent;

(2) adding an alcohol to react with the magnesium halide, to form a solution or dispersion of a magnesium halide-alcohol adduct;

(3) adding an alkyl aluminum halide to react with the magnesium halide-alcohol adduct, to form an intermediate product;

(4) optionally, subjecting the intermediate product to an ultrasonic wave treatment;

(5) adding a titanium compound to perform Ti-supporting reaction;

(6) optionally, subjecting the reaction mixture from step (5) to an ultrasonic wave treatment; and

(7) recovering solid particles, to obtain the ultra high molecular weight polyethylene catalyst,

wherein at least one of steps (4) and (6) is present.

In an embodiment, the magnesium halide is selected from magnesium dihalides, C₁-C₆ alkoxy magnesium halides, C₁-C₆ alkyl magnesium halides, and mixtures thereof. As used herein, the term “halide” encompasses fluoride, chloride, bromide, and iodide. Examples of magnesium halide useful in the present invention include, but are not limited to, magnesium dichloride, magnesium dibromide, methyl magnesium chloride, methyl magnesium bromide, methoxy magnesium chloride, methoxy magnesium bromide, ethoxy magnesium chloride, ethoxy magnesium bromide, butoxy magnesium chloride, butoxy magnesium bromide, and mixtures thereof, with magnesium dichloride being preferred.

The inert solvent used in the present process as a reaction medium may be any solvent which is inert under the reaction conditions. Conveniently, the inert solvent may be a hydrocarbon solvent, for example an aliphatic or aromatic hydrocarbon solvent, such as a C₅ to C₁₅ aliphatic or aromatic hydrocarbon solvent. Examples include, but are not limited to, n-pentane, n-hexane, n-heptane, n-octane, n-decane, cyclic or acyclic isomers of the above, benzene, toluene, and mixtures thereof, with n-hexane, cyclohexane and n-heptane being preferred.

There is not a specific limitation on the amount of the inert solvent used, but it is preferred that the amount of the inert solvent used ranges from 1 to 20 L/mol of the magnesium halide, preferably from 1 to 10 L/mol, and more preferably from 3 to 8 L/mol.

In an embodiment, the inert atmosphere is nitrogen, argon or helium atmosphere.

In an embodiment, the alcohol may be at least one alcohol having from 2 to 20, and preferably from 2 to 8 carbon atoms, for example, ethanol, n-propanol, isopropanol, n-butanol, iso-butanol, 2-ethylbutanol and 2-ethylhexanol. The amount of the alcohol used may range from 0.1 to 10 mol, preferably 1.5 to 8 mol, and more preferably 2.0 to 6 mol, relative to one mole of the magnesium halide.

In an embodiment, in step (2), the reaction between the alcohol and the magnesium halide may be carried out at a temperature ranging from 40 to 130° C., preferably from 50 to 120° C., and more preferably from 60 to 110° C. for a period of time ranging from 10 minutes to 5 hours, preferably from 15 minutes to 4 hours, and more preferably from 30 minutes to 3 hours.

In an embodiment, the alkyl aluminum halide may be represented by a formula of RₘAlX₃₋ₘ, wherein R is independently an alkyl having 1 to 10 carbon atoms; X is independently halogen, and preferably chlorine; 1≦m<3. Examples of useful alkyl aluminum halide include, but are not limited to, diethyl aluminum chloride, ethyl aluminum sesquichloride, ethyl aluminum dichloride, di-n-propyl aluminum chloride, and mixtures thereof, with diethyl aluminum chloride being preferred. The amount of the alkyl aluminum halide used may range from 0.1 to 8 mol, preferably from 0.3 to 7 mol, and more preferably from 0.5 to 5 mol, relative to one mole of the magnesium halide. Alternatively, the amount of the alkyl aluminum halide used may range from 0.1 to 1.0 mol, preferably from 0.2 to 0.9 mol, and more preferably from 0.3 to 0.8 mol, relative to one mole of the alcohol.

In an embodiment, in step (3), the reaction between the alkyl aluminum halide and the magnesium halide-alcohol adduct may be carried out at a temperature ranging from 0 to 130° C., preferably from 10 to 120° C., more preferably from 20 to 110° C., and still more preferably from 40 to 100° C. for a period of time ranging from 5 minutes to 3 hours, preferably from 15 minutes to 2 hours, and more preferably from 30 minutes to 1 hour.

The titanium compounds useful in the present process may be those of formula: Ti(OR³)ₙX₄₋ₙ, wherein R³ is independently an alkyl having from 1 to 6 carbon atoms, X is independently halogen, preferably chlorine or bromine, and more preferably chlorine, and n is an integer of from 0 to 4. Examples include, but are not limited to, titanium tetrachloride, titanium tetrabromide, tetra-n-butoxy titanium, tetraethoxy titanium, triethoxy titanium chloride, diethoxy titanium dichloride, ethoxy titanium trichloride, and tributoxy titanium chloride, with titanium tetrachloride being preferred. These titanium compounds may be used alone or in combination. The amount of the titanium compound used may range from 0.5 to 15 mol, preferably from 0.8 to 10 mol, and more preferably from 1 to 6 mol, relative to one mole of the magnesium halide.

In an embodiment, in step (5), the Ti-supporting reaction may be carried out at a temperature ranging from 0 to 130° C., preferably from 30 to 120° C., and more preferably from 40 to 110° C. for a period of time ranging from 10 minutes to 5 hours, preferably from 30 minutes to 4 hours, and more preferably from 1 to 3 hours.

In the present process, at least one of steps (4) and (6) is present. In other words, the present process comprises at least one ultrasonic wave treatment step. The ultrasonic wave treatments in steps (4) and (6) may employ the same or different parameters.

In an embodiment, ultrasonic wave frequency may range from 20 to 300 KHz, preferably from 20 to 100 KHz, and more preferably from 30 to 80 KHz.

In an embodiment, ultrasonic wave power may range from 30 to 2000 W, preferably from 30 to 500 W, and more preferably from 40 to 200 W.

In an embodiment, ultrasonic wave treatment time may range from 0.5 to 180 minutes, preferably from 0.5 to 60 minutes, more preferably from 0.5 to 30 minutes, and still more preferably from 1 to 10 minutes.

As used herein, the term “ultrasonic wave” has meanings commonly accepted in the art, namely, refers to sonic waves having a frequency above about 20 KHz. Ultrasonic waves diffuse generally in physical media as a longitudinal wave, and are a form of energy spread. Ultrasonic waves have been used widely, and ultrasonic wave generators of various forms and sizes are commercially available.

Without wishing to be limited by any specific theory, it is believed that in the present process, when applied on the reaction mixture, ultrasonic waves cause mechanical impact force on solid particles dispersed in a liquid medium via “cavitation”, thereby effectively promoting the lessening and uniformizing of the solid particles, decreasing the agglomerating of the solid particles, changing the morphology of the solid particles, and/or making active component more effectively and uniformly supporting on the carrier.

There is not a specific limitation on the form of the ultrasonic wave generator used in the present process. In an embodiment, the ultrasonic wave generator is in a form of probe inserted in the reactor, thereby acting directly on the reaction system. In another embodiment, the ultrasonic wave generator is in a form of tank surrounding the reactor and acts directly or through a liquid medium on the reaction system.

In step (6), optionally, after turning off the ultrasonic wave generator, the reaction mixture is maintained at a temperature ranging from 30 to 130° C., preferably from 40 to 130° C., and more preferably from 50 to 120° C. for a period of time ranging from 5 minutes to 3 hours, preferably from 10 minutes to 2.5 hours, and more preferably from 0.5 to 2 hours.

The recovering of the solid catalyst may be carried out in a manner known per se. In an embodiment, the reaction mixture is subjected to settling, filtering, washing with an inert hydrocarbon solvent such as hexane, and vacuum drying or vacuum drying under nitrogen flow, to afford the solid catalyst.

Further disclosed herein is an ultra high molecular weight polyethylene catalyst, which is prepared by the process described above.

The catalyst disclosed herein may be used, together with an alkyl aluminum cocatalyst, in the polymerization of ethylene to prepare ultra high molecular weight polyethylenes. Examples of the alkyl aluminum cocatalyst include, but are not limited to, trimethyl aluminum, triethyl aluminum, triisopropyl aluminum, triisobutyl aluminum, tri-n-hexyl aluminum, trioctyl aluminum, diethyl aluminum hydride, diisobutyl aluminum hydride, and alkyl aluminum halides such as diethyl aluminum chloride, di-isobutyl aluminum chloride, ethyl aluminum sesquichloride, and ethyl aluminum dichloride. Among these, trialkyl aluminums are preferable, and triethyl aluminum and triisobutyl aluminum are more preferable. These alkyl aluminum cocatalysts may be used alone or in combination.

The polyethylene resin prepared by using the catalyst disclosed herein may have an viscosity-average greater than 5,000,000, and a bulk density ranging from 0.15 to 0.30 g/cm³. The polyethylene resin has a porous, loose particle structure, wherein the resin has a “sulcus” like structure on surfaces and has a lot of cracks and channels. Such a particle morphology will facilitate the addition and dispersing of fillers and aids in the resin processing. In the course of making fibers through solution spinning process, the great number of cracks and channels will also facilitate the penetration of a solvent into the particles, thereby facilitating the dissolution of the particles and shortening dissolution time. Furthermore, such a particle morphology will be favor of the preparation of porous or filtering parts so that the ultra high molecular weight polyethylene resin may be advantageously used in the preparation of filter, muffler, filtering core, and the like.

The ultra high molecular weight polyethylene resin disclosed herein may be used in preparation of filtering materials, sheets, pipes, rods, plates, profiles, films, special fibers, and the like.

Compared to the catalysts known in the prior art, the ultra high molecular weight polyethylene catalyst according to the invention achieves the following benefits:

(1) The catalyst exhibits a very high activity. When performing ethylene slurry polymerization by using the catalyst disclosed herein at 0.6 MPa and 60° C. for 1 hour, the catalyst exhibits a polymerization activity of 50,000 gPE/gCat. or higher.

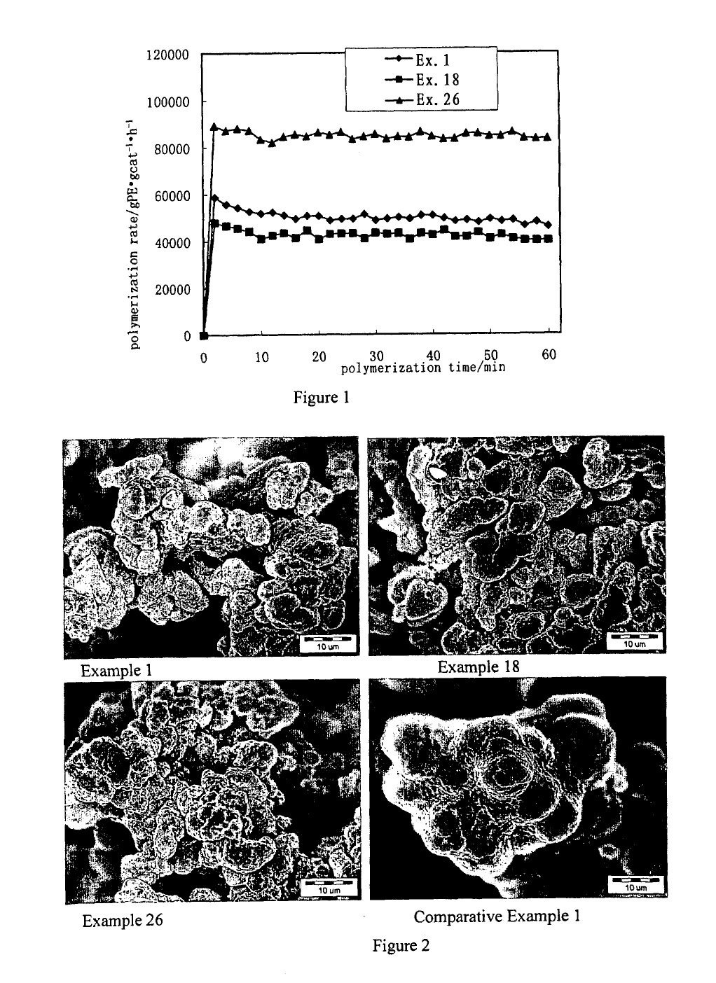

(2) As shown in FIG. 1, the catalyst according to the invention exhibits a smooth reaction kinetics behavior so that the control of the polymerization reaction is easy.

(3) The polyethylene resin obtained by using the catalyst according to the invention has a very high viscosity-average molecular with, for example, above 5,000,000.

(4) The polyethylene resin obtained by using the catalyst according to the invention has a lower bulk density, for example, in a range of from 0.15 to 0.30 g/cm³, and as shown in FIG. 2, the particles are porous and loose.

### EXAMPLES

The following examples are given for further illustrating the invention, but do not make limitation to the invention in any way.

In the following examples, the measurement methods for catalyst properties and polymer properties are as follows:

Catalyst activity: catalyst activity is equal to a ratio of the total weight of UHMWPE obtained in 1-hour polymerization to the weight of the catalyst added.

Molecular weight measurement was performed according to ASTM-D4020-2005. Time that a solution of polyethylene in decalin took to flow out of Ubbelohde viscometer at 135° C. was measured and converted to the intrinsic viscosity η of the polymer. Then the molecular weight, M_{γ}, of the polymer was calculated according to the following equation:

M_{γ}=5.37×10⁴×[η]^{1.37}

Bulk density was measured by using BMY-1 bulk density measuring instrument according to GB/T 1636-1979 (confirmed on 1989).

### Example 1

### Preparation of Catalyst

The atmosphere inside a 250 ml three necked flask equipped with a heating system, a stirring device and a condenser was replaced with highly purified nitrogen gas three times. Then to the flask were charged 60 ml of n-hexane, 10.5 mmol of anhydrous magnesium dichloride, and 52.5 mmol of n-butanol, and the contents in the flask were heated to 70° C. and maintained at that temperature for 0.5 hours to form a solution. After cooling the solution to room temperature, 31.5 mmol of diethyl aluminum chloride was slowly added dropwise to the solution, and the resultant mixture was stirred at 70° C. for 0.5 hours. The flask was transferred into the tank of an ultrasonic wave generator, and ultrasonic waves having a frequency of 40 KHz and a power of 50 W were applied on the contents for 2 minutes. After turning off the ultrasonic wave generator, the contents were continuously stirred at 70° C. for further 0.5 hours. After cooling the reaction mixture to room temperature, 42.0 mmol of titanium tetrachloride was slowly added dropwise thereto, and the resultant mixture was stirred at 70° C. for 2 hours. Then the stirring was stopped, the reaction mixture was left stand to allow solids to settle. After removing the supernatant, the residue was washed with hexane (3×60 ml), and then dried, to give a solid catalyst.

Polymerization Experiment

To a 2 L stainless steel autoclave, which had been evacuated and filled with highly purified nitrogen gas three times, were added 1.2 L of n-hexane, 1.5 mg of the solid catalyst prepared above and 4 ml of 1.0M triethyl aluminum solution in hexane under N₂ atmosphere with stirring. The reactor was heated to 60° C. and then pressurized with ethylene to 0.6 MPa. The polymerization reaction was continued for 1 hour at 60° C. and ethylene was made up during the polymerization reaction to maintain the total pressure of 6.0 MPa. Then the autoclave was cooled and vented, and the product was discharged. After removing solvent, the polymer was dried and weighted, and its properties were measured.

The polymerization performance of the catalyst and resin properties are listed in Table 2. The kinetics curve of the polymerization reaction using the above catalyst is shown in FIG. 1, and the particle morphology of the polymer is shown in FIG. 2.

### Examples 2-17

Catalysts were prepared by following the procedure described in Example 1, except that process conditions or amounts of materials used in the preparation were changes as shown in Table 1 below.

Ethylene polymerization experiments were performed by using these catalysts according to the procedure described in Example 1. Polymerization performance for said catalysts and resin properties are shown in Table 2 below.

### Comparative Example 1

A catalyst was prepared by following the procedure described in Example 1, except that the ultrasonic wave treatment was omitted during the preparation.

Ethylene polymerization experiment was performed by using this catalyst according to the procedure described in Example 1, except that the amount of the catalyst used was changed to 10 mg. Polymerization performance for this catalyst and resin properties are shown in Table 2 below, and particle morphology of polymer is shown in FIG. 2.

TABLE 1
Preparation conditions of catalysts

| | Magnesium | | Diethyl | Titanium | Ultrasonic | Ultrasonic | Ultrasonic wave |
|---|---|---|---|---|---|---|---|
| | dichloride | n-Butanol | aluminum | tetrachloride | wave treatment | wave power | frequency |
| | mmol | mmol | chloride mmol | mmol | time min | W | KHz |
| Example 1 | 10.5 | 52.5 | 31.5 | 42.0 | 2 | 50 | 40 |
| Example 2 | 10.5 | 52.5 | 31.5 | 42.0 | 1 | 50 | 40 |
| Example 3 | 10.5 | 52.5 | 31.5 | 42.0 | 5 | 50 | 40 |
| Example 4 | 10.5 | 52.5 | 31.5 | 42.0 | 8 | 50 | 40 |
| Example 5 | 10.5 | 52.5 | 31.5 | 42.0 | 2 | 30 | 40 |
| Example 6 | 10.5 | 52.5 | 31.5 | 42.0 | 2 | 80 | 40 |
| Example 7 | 10.5 | 52.5 | 31.5 | 42.0 | 2 | 150 | 40 |
| Example 8 | 10.5 | 52.5 | 31.5 | 42.0 | 2 | 50 | 20 |
| Example 9 | 10.5 | 52.5 | 31.5 | 42.0 | 2 | 50 | 30 |
| Example 10 | 10.5 | 52.5 | 31.5 | 42.0 | 2 | 50 | 60 |
| Example 11 | 10.5 | 52.5 | 31.5 | 42.0 | 2 | 50 | 80 |
| Example 12 | 10.5 | 42.0 | 31.5 | 42.0 | 2 | 50 | 40 |
| Example 13 | 10.5 | 63.0 | 31.5 | 42.0 | 2 | 50 | 40 |
| Example 14 | 10.5 | 52.5 | 26.3 | 42.0 | 2 | 50 | 40 |
| Example 15 | 10.5 | 52.5 | 21.0 | 42.0 | 2 | 50 | 40 |
| Example 16 | 10.5 | 52.5 | 31.5 | 31.5 | 2 | 50 | 40 |
| Example 17 | 10.5 | 52.5 | 31.5 | 52.5 | 2 | 50 | 40 |

TABLE 2
Polymerization performance and resin properties

| | Activity | Bulk density | Molecular weight |
|---|---|---|---|
| | gPE · gCat⁻¹ · h⁻¹ | g/cm³ | ×10⁴ |
| Example 1 | 54000 | 0.250 | 550 |
| Example 2 | 38500 | 0.281 | 515 |
| Example 3 | 114000 | 0.220 | 530 |
| Example 4 | 135000 | 0.206 | 500 |
| Example 5 | 51300 | 0.257 | 510 |
| Example 6 | 50300 | 0.249 | 530 |
| Example 7 | 51100 | 0.258 | 549 |
| Example 8 | 50700 | 0.260 | 570 |
| Example 9 | 45000 | 0.268 | 690 |
| Example 10 | 52700 | 0.251 | 550 |
| Example 11 | 51500 | 0.253 | 526 |
| Example 12 | 47500 | 0.266 | 520 |
| Example 13 | 49200 | 0.260 | 495 |
| Example 14 | 47800 | 0.264 | 570 |
| Example 15 | 35300 | 0.278 | 530 |
| Example 16 | 51500 | 0.251 | 565 |
| Example 17 | 57000 | 0.248 | 480 |
| Comparative | 16000 | 0.314 | 350 |
| Example 1 | | | |

### Example 18

### Preparation of Catalyst

The atmosphere inside a 250 ml three necked flask equipped with a heating system, a stirring device and a condenser was replaced with highly purified nitrogen gas three times. Then to the flask were charged 60 ml of n-hexane, 10.5 mmol of anhydrous magnesium dichloride, and 52.5 mmol of n-butanol, and the contents in the flask were heated to 70° C. and maintained at that temperature for 0.5 hours to form a solution. After cooling the solution to room temperature, 21.0 mmol of ethyl aluminum dichloride was slowly added dropwise to the solution, and the resultant mixture was stirred at 70° C. for 1 hour. After cooling the reaction mixture to room temperature, 42.0 mmol of titanium tetrachloride was slowly added dropwise thereto, and the resultant mixture was stirred at 70° C. for 0.5 hours. The flask was transferred into the tank of an ultrasonic wave generator, and ultrasonic waves having a frequency of 40 KHz and a power of 50 W were applied on the contents for 2 minutes. After turning off the ultrasonic wave generator, the contents were continuously stirred at 70° C. for further 2 hours. Then the stirring was stopped, the reaction mixture was left stand to allow solids to settle. After removing the supernatant, the residue was washed with hexane (3×60 ml), and then dried, to give a solid catalyst.

Polymerization Experiment

Ethylene polymerization experiment was performed by using this catalyst according to the procedure described in Example 1.

The kinetics curve of the polymerization reaction using the above catalyst is shown in FIG. 1, and the particle morphology of the polymer is shown in FIG. 2. The polymerization performance of the catalyst and resin properties are listed in Table 4.

### Examples 19-25

Catalysts were prepared by following the procedure described in Example 18, except that process conditions or the type and/or amount of materials used in the preparation were changes as shown in Table 3 below.

Ethylene polymerization experiments were performed by using these catalysts according to the procedure described in Example 1. Polymerization performance for said catalysts and resin properties are shown in Table 4 below.

### Comparative Example 2

A catalyst was prepared by following the procedure described in Example 18, except that the ultrasonic wave treatment was omitted during the preparation.

Ethylene polymerization experiment was performed by using this catalyst according to the procedure described in Example 1, except that the amount of the catalyst used was changed to 10 mg. Polymerization performance for this catalyst and resin properties are shown in Table 4 below.

TABLE 3
Preparation conditions of catalysts

| | Magnesium | | Ethyl aluminum | Titanium | Ultrasonic wave | Ultrasonic | Ultrasonic |
|---|---|---|---|---|---|---|---|
| | dichloride | Alcohol/ | dichloride | tetrachloride | treatment time | wave power | wave frequency |
| | mmol | mmol | mmol | mmol | min | W | KHz |
| Example 18 | 10.5 | n-butanol/52.5 | 21.0 | 42.0 | 2 | 50 | 40 |
| Example 19 | 10.5 | n-butanol/52.5 | 21.0 | 42.0 | 5 | 50 | 40 |
| Example 20 | 10.5 | n-butanol/52.5 | 21.0 | 42.0 | 8 | 50 | 40 |
| Example 21 | 10.5 | n-butanol/52.5 | 21.0 | 42.0 | 2 | 30 | 40 |
| Example 22 | 10.5 | n-butanol/52.5 | 21.0 | 42.0 | 2 | 80 | 40 |
| Example 23 | 10.5 | n-butanol/52.5 | 21.0 | 42.0 | 2 | 150 | 40 |
| Example 24 | 10.5 | ethanol/52.5 | 21.0 | 42.0 | 2 | 50 | 40 |
| Example 25 | 10.5 | isopropanol/52.5 | 21.0 | 42.0 | 2 | 50 | 40 |

TABLE 4
Polymerization performance and resin properties

| | Activity/ | Bulk density | Molecular weight/ |
|---|---|---|---|
| | gPE · (gCat)⁻¹ · h⁻¹ | g/cm³ | ×10⁴ |
| Example 18 | 44000 | 0.276 | 435 |
| Example 19 | 99000 | 0.228 | 450 |
| Example 20 | 126000 | 0.210 | 410 |
| Example 21 | 42000 | 0.275 | 425 |
| Example 22 | 40300 | 0.287 | 440 |
| Example 23 | 43000 | 0.273 | 420 |
| Example 24 | 26900 | 0.295 | 340 |
| Example 25 | 31500 | 0.289 | 310 |
| Comparative | 13500 | 0.318 | 305 |
| Example 2 | | | |

### Example 26

### Preparation of Catalyst

The atmosphere inside a 250 ml three necked flask equipped with a heating system, a stirring device and a condenser was replaced with highly purified nitrogen gas three times. Then to the flask were charged 60 ml of n-hexane, 10.5 mmol of anhydrous magnesium dichloride, and 52.5 mmol of n-butanol, and the contents in the flask were heated to 70° C. and maintained at that temperature for 0.5 hours to form a solution. After cooling the solution to room temperature, 31.5 mmol of diethyl aluminum chloride was slowly added dropwise to the solution, and the resultant mixture was stirred at 70° C. for 1 hour. The flask was transferred into the tank of an ultrasonic wave generator, and ultrasonic waves having a frequency of 40 KHz and a power of 50 W were applied on the contents for 2 minutes. At room temperature, 42.0 mmol of titanium tetrachloride was slowly added dropwise to the flask, and the resultant mixture was stirred at 70° C. for 0.5 hours. Then the ultrasonic wave generator was turned on again to apply ultrasonic waves of 40 KHz and 50 W on the contents for 2 minutes. After turning off the ultrasonic wave generator, the contents were continuously stirred at 70° C. for further 2 hours. Then the stirring was stopped, the reaction mixture was left stand to allow solids to settle. After removing the supernatant, the residue was washed with hexane (3×60 ml), and then dried, to give a solid catalyst.

Polymerization Experiment

Ethylene polymerization experiment was performed by using this catalyst according to the procedure described in Example 1.

The kinetics curve of the polymerization reaction using the above catalyst is shown in FIG. 1, and the particle morphology of the polymer is shown in FIG. 2. The polymerization performance of the catalyst and resin properties are listed in Table 6.

### Examples 27-31

Catalysts were prepared by following the procedure described in Example 26, except that process conditions used in the preparation were changes as shown in Table 5 below.

Ethylene polymerization experiments were performed by using these catalysts according to the procedure described in Example 1. Polymerization performance for said catalysts and resin properties are shown in Table 6 below.

TABLE 5
Preparation conditions of catalysts

| | The first | The first | The first | The second | The second | The second |
|---|---|---|---|---|---|---|
| | ultrasonic wave | ultrasonic wave | ultrasonic wave | ultrasonic wave | ultrasonic wave | ultrasonic wave |
| | treatment time/min | power/W | frequency/KHz | treatment time/min | power/W | frequency/KHz |
| Example 26 | 2 | 50 | 40 | 2 | 50 | 40 |
| Example 27 | 5 | 50 | 40 | 2 | 50 | 40 |
| Example 28 | 2 | 50 | 40 | 5 | 50 | 40 |
| Example 29 | 5 | 30 | 40 | 5 | 30 | 40 |
| Example 30 | 2 | 80 | 40 | 2 | 80 | 40 |
| Example 31 | 2 | 50 | 80 | 2 | 50 | 80 |

TABLE 6
Polymerization performance and resin properties

| | Activity | Bulk density | Molecular weight |
|---|---|---|---|
| | gPE · gCat⁻¹ · h⁻¹ | g/cm³ | ×10⁴ |
| Example 26 | 83000 | 0.232 | 505 |
| Example 27 | 112000 | 0.218 | 490 |
| Example 28 | 99000 | 0.225 | 513 |
| Example 29 | 141000 | 0.204 | 520 |
| Example 30 | 82100 | 0.238 | 514 |
| Example 31 | 82500 | 0.240 | 501 |
| Comparative | 16000 | 0.314 | 350 |
| Example 1 | | | |

### Example 32

200 g of ultra high molecular weight polyethylene resin prepared according to Example 1 and 150 g of active carbon were mixed uniformly by using a mechanical stirrer. Then the resultant mixture was charged into a tube mould and sintered at 250° C. under 1 MPa pressure for 90 minutes. The sintered mixture was cooled to room temperature and then released from the mould, to afford a tube-like filtering core having a plurality of micropores.

The filtering core so prepared can effectively remove deleterious species in water, and is suitable for the potable water treatment in house end.

### Example 33

10 g of ultra high molecular weight polyethylene resin prepared according to Example 1 was filled into the cavity of a specific pen-core mould. After closing the mould, the resin was sintered in an oven at 250° C. for 50 minutes. After cooling the mould, the sintered material was released from the mould, to afford a desired pen-core.

Since the ultra high molecular weight polyethylene particles have a great number of cracks and channels, some microvoids were retained after the sintering so that the pen-core can effectively absorb ink.

### Example 34

80 g of ultra high molecular weight polyethylene resin prepared according to Example 1, 920 g of decalin, an antioxidant and a plastizer were stirred and heated at 100° C. for 2 hours, and then passed through a twin-screw extruder with an extruding temperature of 160° C., to give a spinning solution having a concentration of 8 wt %. The spinning solution was ejected from a spinneret at an outlet rate of 2 m/min into air, and then passed through cooling zone and driving roller, to afford gel-fibers. The gel-fibers were passed successively through first, second, and third stretch boxes to afford high strength, high modulus ultra high molecular weight polyethylene fibers.

### Example 35

91 weight parts ultra high molecular weight polyethylene resin prepared according to Example 1, 7 weight parts polyethylene wax, and 2 weight parts carbon black were plasticized in an extruder and high pressure extruded, and the extruded plasticized resin was passed into a mould, to afford a tube parison, which was heat stretched, cooled, and cut, to afford a tube product.

For the purpose of the specification and the claims attached thereto, when numerical lower limits and numerical upper limits are recited, any ranges from any lower limit to any upper limit are contemplated.

What is claimed is:

1. A process for preparation of an ultra high molecular weight polyethylene catalyst, comprising:
(1) under inert atmosphere, dispersing a magnesium halide in an inert solvent;
(2) adding an alcohol to react with the magnesium halide, to form a solution or dispersion of a magnesium halide-alcohol adduct;
(3) adding an alkyl aluminum halide to react with the magnesium halide-alcohol adduct, to form an intermediate product;
(4) optionally, subjecting the intermediate product to an ultrasonic wave treatment;
(5) adding a titanium compound to perform Ti-supporting reaction;
(6) optionally, subjecting the reaction mixture from step (5) to an ultrasonic wave treatment; and
(7) recovering solid particles, to obtain the ultra high molecular weight polyethylene catalyst,
wherein at least one of steps (4) and (6) is present.

2. The process of claim 1, wherein the ultrasonic wave treatments in steps (4) and (6) employ the same or different parameters, and an ultrasonic wave frequency ranges from 20 to 300 KHz, an ultrasonic wave power ranges from 30 to 2000 W, and ultrasonic wave treatment time ranges from 0.5 to 180 minutes.

3. The process of claim 2, characterized by at least one of the followings:
the ultrasonic wave frequency ranges from 20 to 100 KHz;
the ultrasonic wave power ranges from 30 to 500 W; and
the ultrasonic wave treatment time ranges from 0.5 to 60 minutes.

4. The process of claim 2, characterized by at least one of the followings:
the ultrasonic wave frequency ranges from 30 to 80 KHz;
the ultrasonic wave power ranges from 40 to 200 W; and
the ultrasonic wave treatment time ranges from 1 to 10 minutes.

5. The process of claim 1, wherein step (6) is present, and wherein at the end of the ultrasonic wave treatment in step (6), the reaction mixture is further maintained at a temperature ranging from 30 to 130° C. for a period of time ranging from 5 minutes to 3 hours.

6. The process of claim 1, characterized by at least one of the followings:
the magnesium halide is selected from magnesium dihalides, C₁-C₆ alkoxy magnesium halides, C₁-C₆ alkyl magnesium halides, and mixtures thereof;
the inert solvent is a C₅ to C₁₅ aliphatic or aromatic hydrocarbon solvent;
the amount of the inert solvent used ranges from 1 to 20 L/mol of the magnesium halide;
the alcohol is one having from 2 to 20 carbon atoms;
the amount of the alcohol used ranges from 0.1 to 10 mol, relative to one mole of the magnesium halide;
in step (2), the reaction between the alcohol and the magnesium halide is carried out at a temperature ranging from 40 to 130° C. for a period of time ranging from 10 minutes to 5 hours;
the alkyl aluminum halide is represent by a formula of RₘAlX₃₋ₘ, wherein R is independently an alkyl having from 1 to 10 carbon atoms; X is independently halogen; and 1≦m<3;
the amount of the alkyl aluminum halide used ranges from 0.1 to 8 mol, relative to one mole of the magnesium halide; alternatively, the amount of the alkyl aluminum halide used ranges from 0.1 to 1.0 mol, relative to one mole of the alcohol;
in step (3), the reaction between the alkyl aluminum halide and the magnesium halide-alcohol adduct is carried out at a temperature ranging from 0 to 130° C. for a period of time ranging from 5 minutes to 3 hours;
the titanium compound is represent by a formula of Ti(OR³)ₙX₄₋ₙ, wherein R³ is independently an alkyl having from 1 to 6 carbon atoms, X is independently halogen, and n is an integer ranging from 0 to 4;
the amount of the titanium compound used ranges from 0.5 to 15 mol, relative to one mole of the magnesium halide; and
in step (5), the Ti-supporting reaction is carried out at a temperature ranging from 0 to 130° C. for a period of time ranging from 10 minutes to 5 hours.

7. The process of claim 1, characterized by at least one of the followings:
the magnesium halide is selected from magnesium dichloride, magnesium dibromide, methyl magnesium chloride, methyl magnesium bromide, methoxy magnesium chloride, methoxy magnesium bromide, ethoxy magnesium chloride, ethoxy magnesium bromide, butoxy magnesium chloride, butoxy magnesium bromide, and mixtures thereof.
the inert solvent is selected from n-pentane, n-hexane, n-heptane, n-octane, n-decane, cyclic or acyclic isomers of the above, benzene, toluene, and mixtures thereof;
the alcohol is one having from 2 to 8 carbon atoms;
the amount of the alcohol used ranges from 2.0 to 6 mol, relative to one mole of the magnesium halide;
the alkyl aluminum halide is selected from diethyl aluminum chloride, ethyl aluminum sesquichloride, ethyl aluminum dichloride, di-n-propyl aluminum chloride, and mixtures thereof;
the amount of the alkyl aluminum halide used ranges from 0.5 to 5 mol, relative to one mole of the magnesium halide; alternatively, the amount of the alkyl aluminum halide used ranges from 0.3 to 0.8 mol, relative to one mole of the alcohol;
the titanium compound is selected from titanium tetrachloride, titanium tetrabromide, tetra-n-butoxy titanium, tetraethoxy titanium, triethoxy titanium chloride, diethoxy titanium dichloride, ethoxy titanium trichloride, tributoxy titanium chloride, and mixtures thereof; and
the amount of the titanium compound used ranges from 1 to 6 mol, relative to one mole of the magnesium halide.

8. An ultra high molecular weight polyethylene catalyst prepared by the process according to claim 1.
